(19) United States
(12) Patent Application Publication
(10) Pub. No.: US 2024/0204349 A1
(43) Pub. Date: Jun. 20, 2024

(54) IMPROVED BATTERY

(71) Applicant: W. L. Gore & Associates, Inc., Newark, DE (US)

(72) Inventors: Shaofeng Ran, Kennett Square, PA (US); Lei Zheng, Newark, DE (US)

(21) Appl. No.: 18/287,282

(22) PCT Filed: Apr. 20, 2021
(86) PCT No.: PCT/IB2021/053256

§ 371 Date: Oct. 17, 2023

(51) Int. Cl. H01M 50/30; B01D 69/02; B01D 69/12; B01D 71/32; B01D 71/36; H01M 10/0525

(52) U.S. Cl. CPC H01M 50/394; B01D 69/02; B01D 69/12; B01D 71/32; B01D 71/36; H01M 10/0525; B01D 2325/20; B01D 2325/52

(57) ABSTRACT

There is presented a battery comprising at least one densified expanded polymer membrane covering an opening of a housing. The at least one densified expanded polymer membrane may have a crystallinity of 75% to 100%. In some embodiments, the at least one densified expanded polymer membrane has a CO₂ permeability to water vapour permeability ratio of more than 0.5.

### CROSS-REFERENCE TO RELATED APPLICATION

This application is a national phase application of PCT Application No. PCT/IB2021/053256, internationally filed on Apr. 20, 2021, which is herein incorporated by reference in its entirety for all purposes.

### FIELD

The present disclosure relates to improved vents or covers for a battery and batteries comprising the same.

### BACKGROUND

Batteries, such as lithium-ion batteries, are used to power a wide array of electronic devices including automobiles and mobile phones. While enormous gains have been made in the performance of batteries over the last few decades, improvements to several aspects of battery performance (e.g., battery life, battery output, and the like) are still needed.

For example, batteries that comprise an electrolyte that produces a gas during operation, that gas can increase the pressure within the battery housing that, if left unchecked, can lead to ruptures in the battery housing. However, vents or covers typically used in the art to allow the gas produced from the electrolyte to be released can also allow water vapour to enter into the battery housing, thereby negatively impacting the performance and lifetime of the battery.

Therefore, there remains a need for improved batteries.

### SUMMARY

According to a first aspect there is provided a battery comprising:
a housing comprising an opening;
a positive electrode that is at least partially disposed within the housing;
a negative electrode that is at least partially disposed within the housing;
an electrolyte disposed between the positive electrode and the negative electrode; and
at least one densified expanded polymer membrane covering the opening of the housing,
wherein the electrolyte is configured to release at least one gas during operation of the battery,
wherein the at least one gas is chosen from carbon dioxide (CO₂), hydrogen (H₂), carbon monoxide (CO), methane (CH₄) or any combination thereof; and
wherein the at least one densified expanded polymer membrane has a crystallinity of 75% to 100%;
wherein the at least one densified expanded polymer membrane has a CO₂ permeability to water vapour permeability ratio of more than 0.5.

The at least one densified expanded polymer membrane may be porous. The at least one densified expanded polymer membrane may be microporous.

The at least one densified expanded polymer membrane may an at least one densified expanded polyolefin membrane.

The at least one densified expanded polymer membrane may comprise polyethylene. The at least one densified expanded polymer may be an at least one densified expanded polyethylene membrane.

The at least one densified expanded polymer membrane may comprise polypropylene. The at least one densified expanded polymer may be an at least one densified expanded polypropylene membrane.

The at least one densified expanded polymer membrane may comprise a densified expanded fluoropolymer.

The at least one densified expanded polymer membrane may comprise a copolymer. The at least one densified expanded polymer membrane may comprise a copolymer comprising two or more of the group comprising PTFE, perfluoro(ethyl vinyl ether) (PEVE), vinylidene fluoride (VDF), or chlorotrifluoroethylene (CTFE). For example, the copolymer may be a copolymer of PTFE and PEVE, PTFE and VDF, or PTFE and CTFE. Accordingly, the copolymer may be a copolymer of PTFE.

The at least one densified expanded polymer membrane may comprise a polymer blend. The at least one densified expanded polymer membrane may comprise a polymer blend of PTFE and fluorinated ethylene propylene (FEP), for example.

In embodiments where the at least one densified expanded polymer membrane is a densified expanded fluoropolymer membrane, the at least one densified expanded fluoropolymer membrane may comprise polytetrafluoroethylene (PTFE). Accordingly, the at least one densified expanded fluoropolymer membrane may be an at least one densified expanded PTFE membrane or an at least one densified expanded PTFE copolymer membrane.

For the avoidance of doubt, the term “densified expanded polymer membrane” refers to a polymer membrane that has been expanded below their melting temperature and then after expansion has been densified. Accordingly, it will be understood that the density of the at least one densified expanded polymer membrane is greater than the density of a corresponding expanded polymer membrane that has not been densified. It will be understood to the person skilled in the art that a polymer membrane that has been expanded below their melting temperature and then densified may have a lower porosity than a corresponding polymer membrane of the same material that has been expanded but has not been densified. The step of densification may close a proportion of the pores in the expanded polymer membrane. Therefore, the degree to which an expanded polymer membrane has been densified may allow the permeation of gases across that membrane to be controlled and tailored to the required use.

In some embodiments, the at least one densified expanded polymer membrane may have a density of from 0.8 g/m³ to 2.4 g/m³.

For example, in embodiments where the at least one densified expanded polymer membrane comprises a fluoropolymer, the at least one densified expanded polymer membrane may have a density of from 1.8 g/cm³ to 2.4 g/cm³. The at least one densified expanded polymer membrane may have a density of from 1.8 g/cm³ to 2.3 g/m³. The at least one densified expanded polymer membrane may have a density of from 1.9 g/cm³ to 2.3 g/m³.

It has been surprisingly found that the provision of at least one densified expanded polymer membrane covering the opening of the housing provides high selectivity between CO₂ permeability and water vapour permeability.

Accordingly, the battery of the first aspect is configured to allow gas generated during operation of the battery to escape the battery housing through the at least one densified expanded polymer membrane and to prevent the ingress of water vapour into the battery housing.

In some embodiments, the at least one densified expanded polymer membrane may have a CO₂ permeability to water vapour permeability ratio of more than 0.55. The at least one densified expanded polymer membrane may have a CO₂ permeability to water vapour permeability ratio of more than 0.75. The at least one densified expanded polymer membrane may have a CO₂ permeability to water vapour permeability ratio of more than 1.0. The at least one densified expanded polymer membrane may have a CO₂ permeability to water vapour permeability ratio of more than 1.25. The at least one densified expanded polymer membrane may have a CO₂ permeability to water vapour permeability ratio of more than 1.5.

In some embodiments, the at least one densified expanded polymer membrane may have a CO₂ permeability to water vapour permeability ratio of from about 0.5 to about 1.8. The at least one densified expanded polymer membrane may have a CO₂ permeability to water vapour permeability ratio of from about 0.55 to about 1.8. The at least one densified expanded polymer membrane may have a CO₂ permeability to water vapour permeability ratio of from about 0.75 to about 1.8. The at least one densified expanded polymer membrane may have a CO₂ permeability to water vapour permeability ratio of from about 1.0 to about 1.8. The at least one densified expanded polymer membrane may have a CO₂ permeability to water vapour permeability ratio of from about 1.25 to about 1.8.

In some embodiments, the at least one densified expanded polymer membrane may have a crystallinity of from about 80% to about 100%. In some embodiments, the at least one densified expanded polymer membrane may have a crystallinity of about 85% to about 100%. In some embodiments, the at least one densified expanded polymer membrane may have a crystallinity of from about 90% to about 100%. In some embodiments, the at least one densified expanded polymer membrane may have a crystallinity of from about 95% to about 100%. In some embodiments, the at least one densified expanded polymer membrane may have a crystallinity of from about 96% to about 100%. In some embodiments, the at least one densified expanded polymer membrane may have a crystallinity of from about 97% to about 100%. In some embodiments, the at least one densified expanded polymer membrane may have a crystallinity of from about 99% to about 100%.

In some embodiments the at least one densified expanded polymer membrane may be a sintered densified expanded polymer membrane.

The battery may be a secondary battery. The secondary battery may be a lithium-ion battery.

The positive electrode may be chosen from: Lithium Nickel Manganese Cobalt Oxide (“NMC”), Lithium Nickel Cobalt Aluminum Oxide (“NCA”), Lithium Manganese Oxide (“LMO”), Lithium Iron Phosphate (“LFP”), Lithium Cobalt Oxide (“LCO”), or any combination thereof.

The negative electrode may be chosen from: Lithium, Graphite, Lithium Titanate (“LTO”), a Tin-Cobalt alloy, or any combination thereof.

In some embodiments, the battery may comprise at least one separator. The at least one separator may comprise at least one material chosen from polypropylene, polyethylene, at least one tetrafluoroethylene (TFE) polymer or copolymer, at least one homopolymer of vinylidene fluoride, at least one hexafluoropropylene (HFP)-vinylidene fluoride copolymer, or any combination thereof.

The electrolyte may be an electrolytic solution, wherein the electrolytic solution may comprise at least one solvent and at least one electrolytic salt. The at least one solvent of the electrolytic solution may comprise at least one organic solvent. The at least one organic solvent of the electrolyte may be chosen from propylene carbonate, ethylene carbonate, diethyl carbonate (DEC), dimethyl carbonate (DMC), or mixtures thereof.

The electrolyte may comprise at least one additive, wherein the at least one additive may be configured to release the at least one gas chosen from CO₂, H₂, CO, CH₄ or any combination thereof during operation of the battery. The at least one additive may be selected from the group comprising vinylene carbonate (VC), ethylene sulfite (ES), and fluoroethylene carbonate (FEC).

The electrolyte may be impregnated within the at least one separator.

The battery may comprise a composite vent covering the opening of the housing, the composite vent may comprise the at least one densified expanded polymer membrane. The composite vent may comprise at least one additional membrane. The at least one additional membrane may be located between the housing and the at least one densified expanded polymer membrane.

The at least one additional membrane may comprise a porous fluoropolymer.

The porous fluoropolymer may be expanded PTFE.

The at least one additional membrane may be adhered to the housing on a first side of the at least one additional membrane. The at least one additional membrane may be adhered to the at least one densified expanded polymer membrane on a second side of the at least one additional membrane. Accordingly, the composite vent may be adhered to the housing via the at least one additional membrane.

The composite vent may comprise an intermediate layer located between the at least one densified expanded polymer membrane and the at least one additional membrane. Accordingly, the composite vent may be adhered to the housing via the at least one additional membrane and the at least one densified expanded polymer membrane may be adhered to the at least one additional membrane via the intermediate layers.

The intermediate layer may comprise a perfluoropolymer selected from fluorinated ethylene propylene polymer (FEP) and perfluoroalkoxy alkane (PFA).

Methods of attaching the or each layer or membrane of the composite vent to one another include, but are not limited to, lamination, heat bonding, laser welding, or any combination thereof.

In some embodiments, the at least one densified expanded polymer membrane of the composite vent may have a first density. The at least one additional membrane of the composite vent may have a second density. In some embodiments, the first density and the second density may be the same. In some embodiments, the first density and the second density may be different. In some embodiments, the second density may be less than the first density. In some embodiments, the second density may be greater than the first density.

In some embodiments the housing may be rigid. Accordingly, the housing may be configured to resist deformation to thereby change the shape of the housing. Alternatively, the housing may be flexible. Accordingly, the housing may be configured to at least partially deform to thereby change the shape of the housing. For example, the housing may be a pouch-type housing.

In some embodiments, the housing may comprise at least one of: a metal, a metal alloy, or a combination thereof. In some non-limiting embodiments, the at least one housing comprises at least one of: Iron (Fe), Aluminum (AI), or alloys thereof. In some non-limiting embodiments, the at least one housing comprises at least one plastic.

In some embodiments, the at least one housing comprises at least one opening. In some embodiments, the at least one opening has at least one cross-sectional shape. In some embodiments, the at least one opening has a circular-shaped cross-section. In some embodiments, the at least one opening has a rectangular-shaped cross-section.

In some embodiments, the battery may comprise a plurality of housings. In some embodiments, the plurality of housings may comprise at least a first housing disposed within at least a second housing.

In a second aspect there is provided a composite vent comprising a densified expanded polymer membrane, a porous fluoropolymer layer and an intermediate layer.

The composite vent may be suitable for use in the battery of the first aspect.

Features of the densified expanded polymer membrane of the first aspect may be features of the densified expanded polymer membrane of the second aspect.

Features of the at least one additional layer of the first aspect may be features of the porous fluoropolymer layer of the second aspect.

Features of the intermediate layer of the first aspect may be features of the intermediate layer of the second aspect.

The porous fluoropolymer layer may be configured to be adhered to a housing. Without being limited by theory, the pores of the porous fluoropolymer layer may allow an adhesive to more readily impregnate the composite vent for a firmer or more secure adhesion to a housing.

The intermediate layer may be configured to more readily fix or adhere the densified expanded polymer membrane to the porous fluoropolymer layer.

The composite vent may comprise a second porous fluoropolymer layer and a second intermediate layer. Accordingly, the densified expanded polymer membrane may be connected to a first intermediate layer on a first side of the densified expanded polymer membrane and connected to a second intermediate layer on a second side of the densified expanded polymer membrane. A first porous fluoropolymer layer may be provided on the first intermediate layer. A second porous fluoropolymer layer may be provided on the second intermediate layer.

Methods of attaching the or each layer or membrane of the composite vent to one another include, but are not limited to, lamination, heat bonding, laser welding, or any combination thereof.

### BRIEF DESCRIPTION OF THE FIGURES

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIGS. 1-3 depict embodiments of batteries according to the present disclosure.

FIG. 4 depicts an example test apparatus used to measure CO₂ permeability.

FIG. 5 depicts an exemplary test apparatus used to measure water vapour permeability.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

All prior patents, publications, and test methods referenced herein are incorporated by reference in their entireties.

As used herein, the term “housing” is defined as a casing that encloses components of a battery.

As used herein, an “electrolyte” is defined as any medium that is configured to carry charged particles between a negative electrode and a positive electrode. Electrolytes can take a variety of forms including but not limited to: solutions, acids, bases, gels, polyelectrolytes, ceramics, the like, or any combination thereof.

As used herein, “crystallinity” is defined as the degree of long-range structural order of a material.

Crystallinity is measured in units of percent. A solid with a crystallinity of 0% is completely amorphous, whereas a solid with a crystallinity of 100% is completely crystalline. Crystallinities of the membranes described herein are measured using X-Ray Diffraction (“XRD”). The crystallinities of certain membranes described herein according to some non-limiting embodiments can also be calculated based on the procedure set forth in Satokawa et al., Plastic course-Fluoropolymer, the Nikkan Kogyo Shimbun Edition 3, page 18, (1978), which is incorporated by reference herein in its entirety.

As used herein, carbon dioxide (CO₂) permeability is measured using the “differential pressure” method set forth in JIS K7126-1 standard (equivalent to ASTM D1434) and by using the procedure and test setup described herein in the Examples section. CO₂ permeability has units of cm³·cm/(cm²·s·cmHg).

As used herein, water vapour permeability is measured using the “Lyssy” method set forth herein in the Examples section. Water vapour permeability has units of cm³·cm/(cm²·s·cmHg).

As used herein, the “CO₂ permeability to water vapour permeability ratio” is calculated by dividing CO₂ permeability by water vapour permeability. CO₂ permeability to water vapour permeability ratio has no units (i.e., is dimensionless).

As used herein, a “secondary battery” is a rechargeable battery.

As used herein, “impregnated” means that at least a portion of a first substance fills at least a portion of a second substance. In one non-limiting example, a liquid can be said to impregnate the pores of a porous solid. A first substance can either “partially impregnate” or “fully impregnate” a second substance. A first substance “partially impregnates” a “second substance” when the first substance does not completely fill the second substance (i.e., more of the first substance can be impregnated into the second substance). A first substance “fully impregnates” a “second substance” when the first substance completely fills the second substance, such that no more of the first substance can be impregnated into the second substance.

As used herein, “operation of a battery” includes at least one of: charging a battery, discharging a battery, or any combination thereof.

As used herein, the term “lithium-ion battery” is any battery where lithium-ions are configured to move between a negative electrode and a positive electrode during operation of the battery. Examples of lithium-ion batteries include but are not limited to: lithium-ion polymer (LiPo) batteries, lithium sulfur (Li—S) batteries, and thin-film lithium batteries.

As used herein, “stretch amount equal to” when used in relation to a polymer membrane refers to the percentage of the length of the stretched or expanded polymer membrane compared to the length of the polymer membrane prior to expansion.

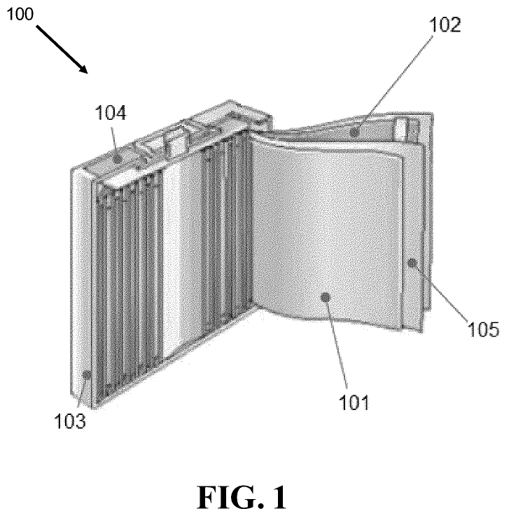

One non-limiting example of a battery according to the present disclosure is shown in FIG. 1. As shown in the exemplary embodiment of FIG. 1, which is a partially exploded view, battery 100 includes a positive electrode 101 and a negative electrode 102 disposed within a housing 103. In some embodiments, the housing 103 may include an opening 104, which may take the form of a pressure vent. In some embodiments, a membrane (not shown) covers the opening 104. In some embodiments, a separator 105 is disposed between the positive electrode 101 and the negative electrode 102. The separator 105 may be impregnated with an electrolyte (not shown).

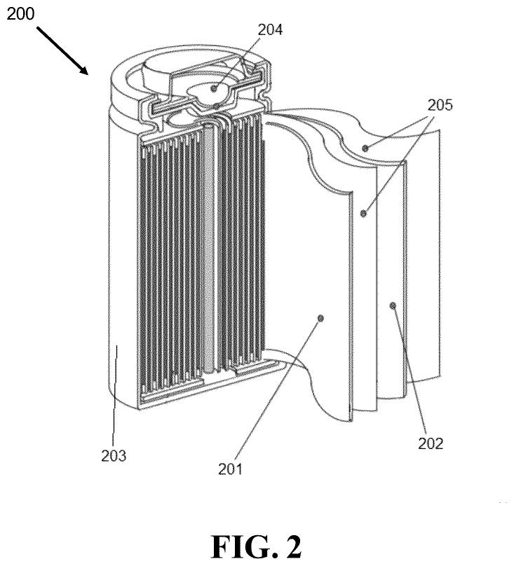

Another non-limiting example of a battery according to the present disclosure is shown in FIG. 2. As shown in the exemplary embodiment of FIG. 2, which is also a partially exploded view, battery 200 includes a positive electrode 201 and a negative electrode 202 disposed within a cylindrical housing 203. In some embodiments, the cylindrical housing 203 may include an opening 204, which may take the form of a gas release vent. In some embodiments, a membrane (not shown) covers the opening 204. In some embodiments, a plurality of separators 205 is disposed between the positive electrode 201 and the negative electrode 202. The plurality of separators 205 may be impregnated with an electrolyte (not shown).

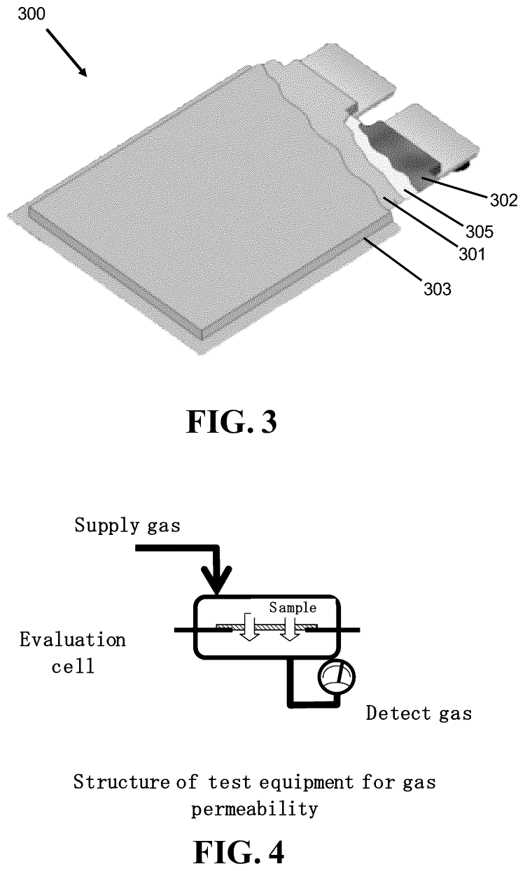

Yet another non-limiting example of a battery according to the present disclosure is shown in FIG. 3. As shown in the exemplary embodiment of FIG. 3, which is also a partially exploded view, battery 300 includes a positive electrode 301 (in the form of a cathode foil) and a negative electrode 302 (in the form of an anode foil) disposed within a housing 303. In some embodiments, the housing 303 may include an opening (not shown). In some embodiments, a membrane (not shown) covers the opening (not shown). In some embodiments, separator 305 is disposed between the positive electrode 301 and the negative electrode 302. The separator 305 may be impregnated with an electrolyte (not shown).

### EXAMPLES

Exemplary non-limiting membrane samples according to the present disclosure were tested as described herein. The results are set forth below in Table 1. Table 1 illustrates test results for crystallinity, CO₂ permeability, water vapour permeabilities, and CO₂ to water vapour permeability ratio, for each numbered sample below (i.e., each of sample membranes 1-5 and comparative sample membranes 1-2).

Crystallinities were measured using X-Ray diffraction (“XRD”) as described below.

CO₂ permeabilities and water vapour permeabilities were measured using the procedures set forth below.

TABLE 1
Properties of Sample Membranes

| | | | | Water vapour | |
|---|---|---|---|---|---|
| | | Degree of | CO₂ permeability | permeability | CO₂ permeability/ |
| Sample film | Density | Crystallinity | cm³ · cm/ | cm³ · cm/ | Water vapour |
| no. | g/cm³ | % | (cm² · s · cmHg) | (cm² · s · cmHg) | permeability ratio |
| 1 | 1.98 | 86.4 | 5.60 × 10⁻⁹ | 7.27 × 10⁻⁹ | 0.77 |
| 2 | 2.15 | 96.6 | 1.48 × 10⁻⁹ | 2.16 × 10⁻⁹ | 0.69 |
| 3 | 2.27 | 97.4 | 1.27 × 10⁻⁹ | 7.30 × 10⁻¹⁰ | 1.74 |
| 4 | 2.16 | 96.6 | 8.91 × 10⁻¹⁰ | 1.52 × 10⁻⁹ | 0.59 |
| 5 | 1.86 | 79.2 | 6.10 × 10⁻⁹ | 1.12 × 10⁻⁸ | 0.55 |
| Comparative 1 | 2.22 | 73.0 | 1.18 × 10⁻⁹ | 2.63 × 10⁻⁹ | 0.45 |
| Comparative 2 | 2.15 | 46.3 | 1.50 × 10⁻⁹ | 3.45 × 10⁻⁹ | 0.43 |

### Example 1: Procedure for Preparation of Sample Film 1

The PTFE resin was mixed with lubricant (Isopar K, Exxon, Houston, TX), at a concentration of 0.268 g/g, subsequently blended, compressed into a cylindrical pellet, and thermally conditioned for 24 hours at a temperature of 22° C. The cylindrical pellet was then extruded into a tape with thickness of 0.610 mm through a rectangular die at a reduction ratio of 182. The resultant tape was then dried in order to remove the lubricant.

The dried PTFE tape was then expanded in the y-direction (i.e. the machine direction or the longitudinal direction) between heated drums at a linear rate of about 8%/second, a drum temperature of 315° C., and stretch amount equal to 276%. The tape was then expanded in the x-direction (i.e. the transverse direction) at a linear rate of about 33%/second, a temperature of about 300° C., and a stretch amount equal to 599%. The resulting product was an unsintered expanded PTFE membrane with a density of about 0.22 g/cm³

The resulting unsintered expanded PTFE membrane was compressed and densified at a temperature of 370° C. and a pressure of 250 psi based on the teachings of U.S. Pat. Nos. 5,374,473 and 7,521,010 B2. The resulting article is a sintered and densified ePTFE film with a thickness of about 0.026 mm.

### Example 2: Procedure for Preparation of Sample Film 2

The PTFE resin was mixed with lubricant (Isopar K, Exxon, Houston, TX), at a concentration of 0.167 g/g, subsequently blended, compressed into a cylindrical pellet, and thermally conditioned for 24 hours at a temperature of 70° C. The cylindrical pellet was then extruded into a tape with thickness of 0.711 mm through a rectangular die at a reduction ratio of 88. The resultant tape was then dried in order to remove the lubricant.

The dried PTFE tape was then expanded in the y-direction between heated drums at a linear rate of about 46%/second, a drum temperature of 315° C., and stretch amount equal to 1,032%. The tape was then expanded in the x-direction at a linear rate of about 56%/second, a temperature of about 300° C., and a stretch amount equal to 2,863%. The resulting product was an unsintered expanded PTFE membrane with a density of about 0.20 g/cm³.

The resulting unsintered expanded PTFE membrane was compressed and densified at a temperature of 370° C. and a pressure of 250 psi based on the teachings of U.S. Pat. Nos. 5,374,473 and 7,521,010 B2. The resulting article is a sintered and densified ePTFE film with a thickness of about 0.023 mm.

### Example 3: Procedure for Preparation of Sample Film 3

The PTFE resin was mixed with lubricant (Isopar K, Exxon, Houston, TX), at a concentration of 0.184 g/g, subsequently blended, compressed into a cylindrical pellet, and thermally conditioned for 24 hours at a temperature of 49° C. The cylindrical pellet was then extruded into a tape with thickness of 0.635 mm through a rectangular die at a reduction ratio of 182. The resultant tape was then dried in order to remove the lubricant.

The dried PTFE tape was then expanded in the y-direction between heated drums at a linear rate of about 51.5%/second, a drum temperature of 320° C., and stretch amount equal to 319%. The tape was then expanded in the x-direction at a linear rate of about 42.2%/second, a temperature of about 320° C., and a stretch amount equal to 879%. The resulting product was an unsintered expanded PTFE membrane with a density of about 0.12 g/cm³.

The resulting unsintered expanded PTFE membrane was densified at a temperature of 370° C. and a pressure of 250 psi based on the teachings of U.S. Pat. Nos. 5,374,473 and 7,521,010 B2. The resulting densified ePTFE film was then placed in a pantograph machine wherein the material was heated above the crystalline melt temperature of PTFE by exposure to air temperature of about 370ºC for a period of 84 seconds. The sample, while still heated, was then stretched in the x-direction at a stretch amount equal to 514% and average engineering strain rate of 8%/second. The resulting article is a sintered and densified ePTFE film with a thickness of about 0.005 mm.

### Example 4: Procedure for Preparation of Sample Film 4

The PTFE resin was mixed with lubricant (Isopar K, Exxon, Houston, TX), at a concentration of 0.184 g/g, subsequently blended, compressed into a cylindrical pellet, and thermally conditioned for 24 hours at a temperature of 49° C. The cylindrical pellet was then extruded into a tape with thickness of 0.686 mm through a rectangular die at a reduction ratio of 182. The resultant tape was then dried in order to remove the lubricant.

The dried PTFE tape was then expanded in the y-direction between heated drums at a linear rate of about 98%/second, a drum temperature of 320° C., and stretch amount equal to 718%. The tape was then expanded in the x-direction at a linear rate of about 50%/second, a temperature of about 320° C., and a stretch amount equal to 629%. The resulting product was an unsintered expanded PTFE membrane with a density of about 0.14 g/cm³.

The resulting unsintered expanded PTFE membrane was densified at a temperature of 370° C. and a pressure of 250 psi based on the teachings of U.S. Pat. Nos. 5,374,473 and 7,521,010 B2. The resulting densified ePTFE film was then placed in a pantograph machine wherein the material was heated above the crystalline melt temperature of PTFE by exposure to air temperature of about 370° C. for a period of 180 seconds. The sample, while still heated, was then stretched in the x-direction at a stretch amount equal to 308% and average engineering strain rate of 8%/second. The resulting article is a sintered and densified ePTFE film with a thickness of about 0.006 mm.

### Example 5: Procedure for Preparation of Sample Film 5

The PTFE resin was mixed with lubricant (Isopar K, Exxon, Houston, TX), at a concentration of 0.268 g/g, subsequently blended, compressed into a cylindrical pellet, and thermally conditioned for 24 hours at a temperature of 22ºC. The cylindrical pellet was then extruded into a tape with thickness of 0.610 mm through a rectangular die at a reduction ratio of 182. The resultant tape was then dried in order to remove the lubricant.

The dried PTFE tape was then expanded in the y-direction between heated drums at a linear rate of about 8%/second, a drum temperature of 315° C., and stretch amount equal to 276%. The tape was then expanded in the x-direction at a linear rate of about 33%/second, a temperature of about 300° C., and a stretch amount equal to 599%. The resulting product was an unsintered expanded PTFE membrane with a density of about 0.22 g/cm³.

The resulting unsintered expanded PTFE membrane was compressed and densified at a temperature of 370° C. and a pressure of 250 psi based on the teachings of U.S. Pat. Nos. 5,374,473 and 7,521,010 B2. The resulting article is a sintered and densified ePTFE film with a thickness of about 0.026 mm. This film was then further annealed in the pantograph machine at 390° C. for 20 minutes.

### Comparative Example 1

Comparative example 1 is available as “NITOFLON NO.900UL” PTFE film made by Nitto having an average thickness of 170 μm.

### Comparative Example 2

Comparative example 2 is available as “NEOFLON® PFA film AF-0250” made from Danikin having an average thickness of 250 μm.

### Measurement of Degree of Crystallinity

The experiment was carried out on a Rigaku SmartLab XRD, operating a Cu Ka source with a 40 kV tube voltage and 200 mA current. The beam was collimated using Bragg-Brentano optics, a 5° soller slit, ½ automatic variable incident slit (beam height), and 5 mm length limiting slit (beam width). The beam was directed onto an approximately 2×3 cm sample, secured to a non-reflective silicon holder using Kapton tape around the edges of the sample.

On the receiving optics side, the scattered x-rays were passed through a Ni metal Kβ filter, a 5° soller slit, and 20 mm receiving slits. The scattered intensities were collected with a “D/teX Ultra 250” detector operating in 1D mode. The sample was scanned from a range of 5-35° 2θ, with a 0.05° increment and at a rate of 10º/min.

The obtained scattering intensities were plotted as a function of the scattering angle (2θ), from approximately 5-35° 2θ. This scattering profile was de-convoluted into crystalline and non-crystalline scattering peaks using Pearson7 and Gauss function with two peaks at 18° and 16.5°. The 18° peak is the crystalline peak, and the 16.5° peak is the amorphous peak. The degree of crystallinity was determined using the equation below by Satokawa et al., Plastic course-Fluoropolymer, the Nikkan Kogyo Shimbun Edition 3, page 18, (1978), where Ic is the peak area of crystalline phase and Ia is the peak area of amorphous phase.

$$Crystallnity \% = \frac{100 Ic}{Ic + 0.66 Ia} \%$$

### Measurement of CO₂ Permeability

Generally, CO₂ permeability can be measured by commercial measurement equipment, such as the commercial measurement equipment described herein. Two non-limiting examples of methods that can be used to measure of CO₂ permeability—the differential pressure method and the equal pressure method.

Herein, determination of the CO₂ permeability of the materials was carried out in accordance with Japanese Industrial Standards JIS K7126-1 (Plastics—Film and sheeting—Determination of gas-transmission rate—Part 1: Differential-pressure method, equivalent to ASTM D1434). Specifically, the instrument used to test the gas permeation of the materials was a Gas Permeability Analyzer GTR series (eq. GTR-11MJGG) by GTR Tech. The test setup was shown in FIG. 4. The permeant used was CO₂ at 1.0 kgf/cm² supply pressure and the test temperature was 30° C.

A test sample was cut to approximately 5 cm by 5 cm and loaded on a test cell, where the pervious area was a disk with 4.4 cm in diameter and 15.2 cm² in surface area. The sample was affixed in the instrument diffusion cell and conditioned to the desirable pressure. CO₂ gas transmission rate was reported by the instrument in cm³/(m²·24h·atm). CO₂ gas permeability coefficient of each sample was calculated by multiplying the CO₂ gas transmission rate by the thickness of the test sample. Results were reported in the unit of cm³·cm/(cm²·s·cmHg).

### Measurement of Water Vapour Permeability

Generally, water vapour permeability can be measured by commercial measurement equipment. One non-limiting method that can be used is the equal pressure method.

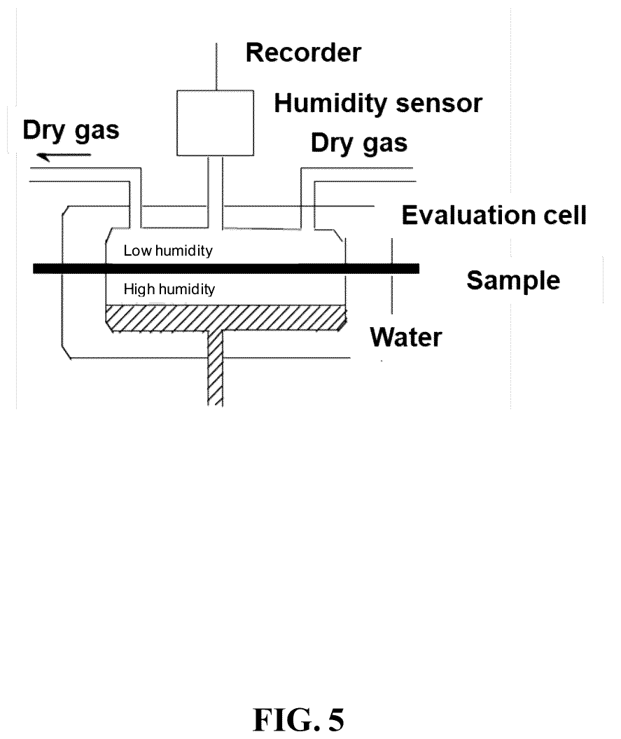

Herein, determination of the water vapour permeability of the materials was carried out in accordance with Japanese Industrial Standards JIS K7129-A (Plastics—Film and sheeting—Determination of water vapour transmission rate, equivalent to ASTM F1249). Specifically, the instrument used to test the water vapour permeation of the materials was a Water Vapour Permeation Analyzer Lyssy L80-4000 by Systech, Illinois. The test setup was shown in FIG. 5. Test samples were cut to approximately 10 cm by 10 cm, held by a sample card where a pervious area was a disk with approximately 8 cm in diameter and 50 cm² in surface area. The pre-conditioned specimen is mounted in the test cell as to form a sealed barrier between two chambers. The lower chamber was at 100% RH with the water vapor pressure at 55.3 mmHg. The higher chamber was at about 10% RH. The test temperature was 40° C.

Water vapour transmission rate, or water vapour permeability, was reported by the instrument in g/(m² day). The water vapour permeability coefficient of each sample was calculated by multiplying the water vapour transmission rate by the thickness of the test sample. Results were reported in the unit of cm³·cm/(cm²·s·cmHg).

Accordingly, the example films 1-5 show a clear improvement in the ratio of CO₂ permeability to water vapour permeability when compared to comparative examples 1 and 2. Therefore, batteries comprising the films or membranes of examples 1-5 are more stable as any gas produced during use of the battery can be readily vented from the battery housing whilst preventing ingress of water vapour.

While there has been hereinbefore described approved embodiments of the present invention, it will be readily apparent that many and various changes and modifications in form, design, structure and arrangement of parts may be made for other embodiments without departing from the invention and it will be understood that all such changes and modifications are contemplated as embodiments as a part of the present invention as defined in the appended claims.

1. A battery comprising:
a housing comprising an opening;
a positive electrode that is at least partially disposed within the housing;
a negative electrode that is at least partially disposed within the housing;
an electrolyte disposed between the positive electrode and the negative electrode; and
at least one densified expanded polymer membrane covering the opening of the housing,
wherein the electrolyte is configured to release at least one gas during operation of the battery,
wherein the at least one gas is chosen from Carbon Dioxide (CO₂), Hydrogen (H₂), Carbon Monoxide (CO), Methane (CH₄) or any combination thereof; and
wherein the at least one densified expanded polymer membrane has a crystallinity of 75% to 100%;
wherein the at least one densified expanded polymer membrane has a CO₂ permeability to water vapour permeability ratio of more than 0.5.

2. The battery of claim 1, wherein the at least one densified expanded polymer membrane is an at least one densified expanded fluoropolymer membrane.

3. The battery of claim 2, wherein the at least one densified fluoropolymer membrane comprises PTFE.

4. The battery of claim 1, wherein the at least one densified expanded polymer membrane comprises a copolymer.

5. The battery of claim 1, wherein the at least one densified expanded polymer membrane has a CO₂ permeability to water vapour permeability ratio of more than 0.55.

6. The battery of claim 1, wherein the at least one densified expanded polymer membrane has a CO₂ permeability to water vapour permeability ratio of more than 1.0.

7. The battery of claim 1, wherein the at least one densified expanded polymer membrane has a density of 0.8 g/cm³ to 2.4 g/cm³.

8. The battery of claim 1, wherein the at least one densified expanded polymer membrane is sintered.

9. The battery of claim 1, wherein the battery is a secondary battery.

10. The battery of claim 9, wherein the secondary battery is a lithium-ion battery.

11. The battery of claim 1, wherein the battery comprises a composite vent covering the opening of the housing, the composite vent comprising the at least one densified expanded polymer membrane and at least one additional membrane, the at least one additional membrane being located between the housing and the at least one densified expanded polymer membrane.

12. The battery of claim 11, wherein at least one additional membrane comprises a porous fluoropolymer.

13. The battery of claim 12, wherein the porous fluoropolymer is expanded PTFE.

14. The battery of claim 11, wherein the composite vent comprises an intermediate layer located between the at least one densified expanded polymer membrane and the at least one additional membrane.

15. The battery of claim 14, wherein the intermediate layer comprises a perfluoropolymer selected from fluorinated ethylene propylene polymer (FEP), perfluoroalkoxy alkane (PFA), a terpolymer of tetrafluoroethylene, hexafluoropropylene and vinylidene fluoride (THV), polyvinylidene fluoride (PVDF), and ethylene tetrafluoroethylene (ETFE).
